(19) United States
(12) Patent Application Publication
(10) Pub. No.: US 2006/0027145 A1
(43) Pub. Date: Feb. 9, 2006

(54) Tinted texturing mixture and method of application to a surface

(76) Inventor: Kristi L. McCampbell, Plano, TX (US)

Correspondence Address: MICHAEL L. DIAZ, P.C., 555 REPUBLIC DRIVE, SUITE 200, PIANO, TX, 75074, US

(21) Appl. No.: 10/894,742

(22) Filed: Jul. 20, 2004

(51) Int. Cl. C04B 16/00; C04B 14/00

(52) U.S. Cl. 106/712

(57) ABSTRACT

The present invention is a tinted texturing mixture. The tinted texturing mixture includes a first texturing material and a second tinting substance. The two ingredients are thoroughly mixed. Preferably, the texturing material is a dry joint compound or a concrete material. The second tinting substance is preferably a latex paint. The tinted texturing mixture is then applied to a surface. The present invention enables the application of just one coat of material to a wall.

### BACKGROUND OF THE INVENTION

1. Field of the Invention

This invention relates to decorative surface applications. Specifically, the present invention relates to a tinted texturing mixture applied to a surface.

2. Description of the Related Art

For many years, the application of paint to a wall has been used to enhance the appearance of a room. Unique and varied methods have been used effectively in decorating rooms. One of the more common types of decoration is to provide a texture to a wall and is often referred to as “mudding.” Mudding involves the process of applying a pre-mixed paste or plaster, which is applied to the wall as a base coating. The paste provides a textured surface. After the paste is applied to the wall and allowed to dry, paint is applied to the surface of the textured wall. Oftentimes, several coats of paint are necessary to successfully and fully cover the textured wall. However, the existing method of creating a textured wall is both tedious and time consuming.

With the existing method, rather than merely applying one coat, several applications of paste or paint must be applied to the surface. With the existing method of creating a textured wall, a plaster or paste mix is first applied to a wall. A texturing technique is usually utilized to provide a texture to the surface of the wall. For example, a putty knife may be used to create broad sweeping strokes. Other tools may be used to provide designs or imprints upon the plaster. The paste usually has a color that is different than the paint which is applied to the exterior surface of the paste. Typically, the paste is gray or white, which often contrasts sharply with the coat of paint. The paste usually must be allowed to dry for at least 24 hours before applying paint. After waiting the 24 hours, paint is applied to the textured surface. Because of the uneven surface, several coats of paint may be necessary. The current method of mudding therefore requires a significant amount of time and effort. Additionally, because the surface is textured with the paste, paint is applied to a very uneven surface, making it much more difficult to fully cover the textured surface.

In addition to the time and effort necessary to apply the texturing material to a wall, the wall is susceptible to damage, which is noticeable. FIG. 1 is a side cross-section view of a texturing material such as a paste or mud 10 applied to a surface 12. A coating of paint or tinted material 14 is illustrated over the mud. When the surface is damaged, a portion of the outer surface (paint) may chip off of the paste forming a gouge 16, thereby exposing the undercoating (paste). However, as stated above, the paste is typically a white or gray color, which is not tinted. Thus, when the exterior paint surface is damaged, the white or gray color of the undercoating (paste) is exposed, which is very unsightly.

Thus, it would be a distinct advantage to have a tinted texturing mixture useable for application on a surface and a method of applying the texturing mixture to a wall. It is an object of the present invention to provide such a system and method.

### SUMMARY OF THE INVENTION

In one aspect, the present invention is a tinted texturing mixture for application on a surface. The tinted texturing mixture includes a first texturing material and a second substance having a coloring property. The first substance is mixed with the second substance to form the tinted texturing mixture. When the two substances are mixed together, the consistency is greater than paint. The tinted texturing mixture provides a consistent color through the mixture. The tinted texturing mixture is then applied as desired to the surface.

In another aspect, the present invention is a method of mixing a tinted texturing material. The method begins by placing a first substance, which has a consistency greater than paint in a mixing container. A second substance having a coloring property is also placed in the mixing container. Next, the two substances are thoroughly mixed together to form a tinted texturing material. The tinted texturing material is then applied to a surface.

In still another aspect, the present invention is a tinted texturing mixture for application on a surface. The tinted texturing mixture includes a first substance having a consistency greater than paint when mixed with another substance. This first substance is a conventional joint compound having an adherence property. This first substance is mixed with a second substance having a coloring property. The second substance is a latex paint. The first substance is mixed with the second substance in a ratio of approximately one to one to form the tinted texturing mixture. The tinted texturing mixture provides a consistent color through the mixture. The tinted texturing mixture is then applied to the surface.

### BRIEF DESCRIPTION OF THE DRAWINGS

FIG. 1 (Prior Art) is a side cross-section view of a texturing material or mud applied to a surface with a paint applied to an exterior surface of the texturing material;

FIG. 2 is a side cross-section view of a mixture of texturing material and a tinting substance applied to a surface in the preferred embodiment of the present invention; and

FIG. 3 is a flow chart outlining the steps for mixing a tinted texturing material and applying the mixture to a surface according to the teachings of the present invention

### DESCRIPTION OF THE INVENTION

A tinted texturing mixture and a method of applying the tinted texturing mixture is disclosed. The present invention utilizes a mixture of a texturing material, such as a dry joint compound or a paste, with a tinting substance, such as latex paint. In the preferred embodiment of the present invention, the texturing material is a conventional dry joint compound. Dry joint compound, when mixed with other appropriate substances, provides a consistency suitable for texturing a wall. Additionally, joint compound effectively adheres to most surfaces. However, any substance, which has a consistency thicker than paint (either before or after mixing), may be used. In addition, although latex paint effectively colors the joint compound, other tinting substances may be used.

To mix the ingredients of the texturing material (e.g., joint compound) with the tinting substance (e.g., latex paint), a mixing container is utilized. The texturing material is mixed with the tinting substance within the mixing container. Preferably, for joint compound and latex paint, a mixture of approximately one to one effectively tints or colors the joint compound. However, any mixture ratio may be used which enables the tinting of the texturing material. The ingredients should be thoroughly mixed to provide a consistent color throughout all of the mixture.

After mixing the ingredients, the tinted texturing mixture may be applied as one coat to any desired surface. Optionally, the mixture may be applied with any of various applicators, such as mud knives, brushes, etc. The mixture is then allowed to dry. The mixture provides a texturing surface with only one coat being necessary to apply to the surface. Additionally, coats of the mixture may be optionally applied as desired. Further exterior designs may also be impressed upon the exterior surface of the mixture, such as stenciling, painting, glazing, fresco painting, etc.

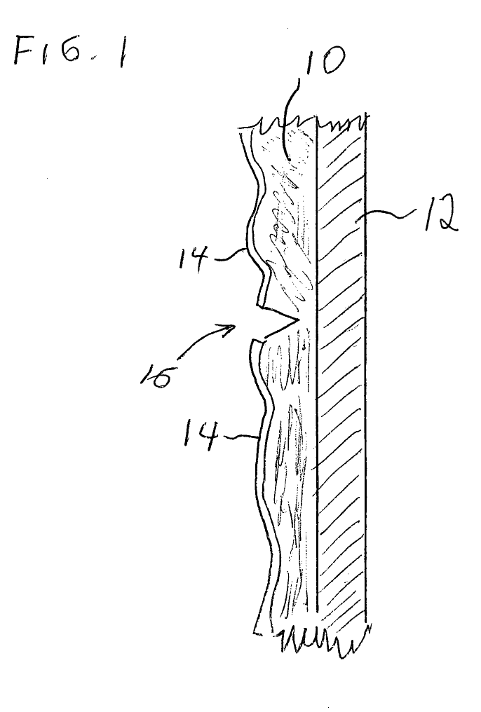

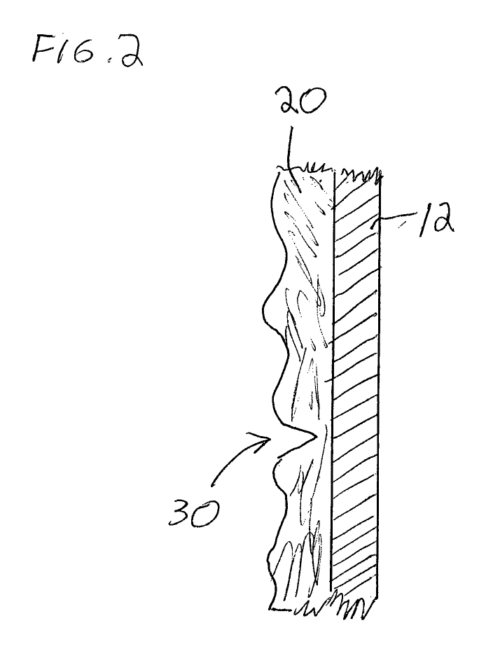

FIG. 2 is a side cross-section view of a mixture 20 of texturing material and a tinting substance applied to a surface 12 in the preferred embodiment of the present invention. Unlike the mudding application of FIG. 1, the present invention may provide a consistent color throughout the entire depth of the mixture. FIG. 2 illustrates a gouge 30 in the mixture. Therefore, if the substance is chipped or damaged, the color within its interior provides a color consistent with the exterior surface of the mixture.

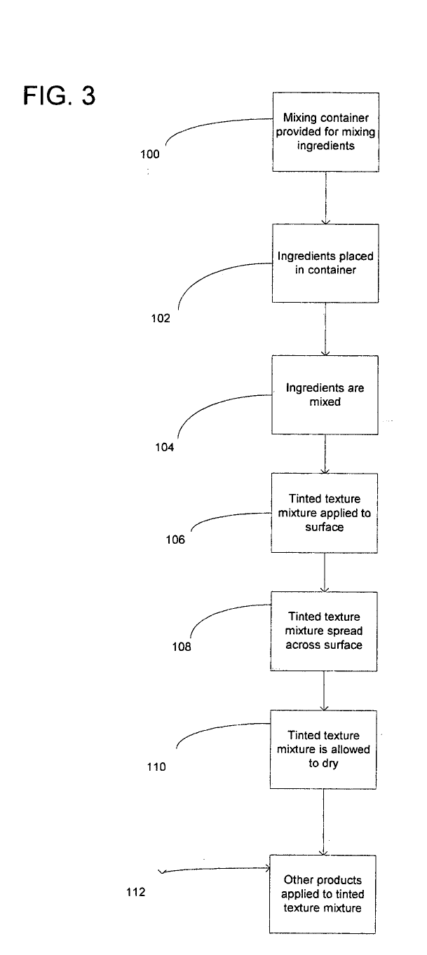

FIG. 3 is a flow chart outlining the steps for mixing a tinted texturing material and applying the mixture to a surface 12 according to the teachings of the present invention. With reference to FIGS. 2 and 3, the steps of the method will now be explained. The method begins with step 100 where a mixing container is provided for mixing the ingredients. In step 102, both the texturing material and the tinting substance are placed in the mixing container. The texturing material may be any substance providing a heavier consistency than paint when mixed with another suitable substance. In the preferred embodiment of the present invention, the texturing material is dry joint compound. The dry joint compound provides an appropriate consistency for texturing surfaces when mixed with an appropriate second substance. In addition, joint compound adheres to a surface sufficiently and does not easily chip or crack. The tinting substance is preferably latex paint, which provides adequate color to the texturing material. Also, in a preferred embodiment of the present invention, the mixing ratio is approximately one to one. However, any ratio may be used to provide color to the texturing material. In addition, an anti-mold and anti-bacterial substance may be optionally added to the mixture to provide further beneficial attributes to the mixture. Other substances may also be added to increase the strength or texture of the mixture, such as threads for binding the ingredients together.

The method then moves to step 104 where the two substances are thoroughly mixed together, thereby creating a tinted texturing mixture. Alternately, the substances may be partially mixed (e.g., swirled together) to provide unique coloring to the mixture. Next, in step 106, the mixture is then applied to a surface, such as a wall, floor or ceiling. The mixture may be applied in a variety of ways, such as applying the tinted texturing mixture with a putty or taping knife to the surface. Next, in step 108, the tinted texturing mixture may be spread upon the surface to provide desired patterns or textures, such as broad strokes or specific geometric patterns. In step 110, the mixture is allowed to dry. In step 112, other products or coats may be optionally applied. For example, a glaze or paint may be applied over the tinted texturing mixture. In an alternate embodiment of the present invention, glitter may also be applied over the tinted texturing mixture.

The tinted texturing mixture may be applied to any surface, such as a wall, a floor or a ceiling. For example, in regards to a floor, the texturing mixture may be a concrete material with a tinting substance mixed together. Currently, paint is applied to concrete floors to enhance the beauty of the flooring. However, with the present invention, paint or other tint substance may be added to the concrete prior to application. The concrete may then be applied to the flat surface. In another example, the mixture may be applied to a ceiling to provide a textured tinted ceiling.

The present invention provides many advantages over existing texturing products. The present invention enables a single application to effectively texture and tint a surface, rather than the multiple applications required with existing methods. In addition, the present invention prevents unsightly gouges or dents within the texturing surface from being exposed. The tinted texturing mixture has the same consistent color at any depth of the mixture. Therefore, when dents or gouges are formed, the color remains the same. In the preferred embodiment of the present invention, dry joint compound provides an appropriate consistency for a texture wall when mixed with an appropriate second substance. In addition, the joint compound is resilient to cracking and binds well with latex paint. Additionally, the joint compound effectively adheres to a surface.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A tinted texturing mixture for application on a surface, the tinted texturing mixture comprising:
a first texturing substance;
a second substance having a coloring property;
the first substance being mixed with the second substance to form the tinted texturing mixture, the tinted texturing mixture having a consistency greater than paint;
whereby the tinted texturing mixture provides a color throughout the mixture, the tinted texturing mixture being applied to the surface.

2. The tinted texturing mixture of claim 1 wherein the first texturing substance is a conventional dry joint compound.

3. The tinted texturing mixture of claim 1 wherein the second substance is a conventional latex paint.

4. The tinted texturing mixture of claim 1 wherein the first texturing substance is a concrete material.

5. The tinted texturing mixture of claim 1 wherein the first texturing substance is mixed with the second substance at a ratio of approximately one to one.

6. The tinted texturing mixture of claim 1 wherein a third substance is mixed with the first and second substance to form the mixture.

7. The tinted texturing mixture of claim 6 wherein the third substance is a binder to assist in strengthening the mixture.

8. The tinted texturing mixture of claim 1 wherein a fourth substance is at least partially applied to an exterior surface of the tinted texturing mixture after the tinted texturing mixture is applied to the surface.

9. The tinted texturing mixture of claim 8 wherein the fourth substance is a paint.

10. The tinted texturing mixture of claim 8 wherein the fourth substance is a glaze.

11. The tinted texturing mixture of claim 1 wherein the first texturing substance includes an adherence property to adhere the tinted texturing mixture to the surface.

12. A method of mixing a tinted texturing material, the method comprising the steps of:
providing a mixing container;
providing a first substance having a coloring property;
providing a second substance for use in increasing a consistency of a mixture with the first substance; and
mixing the first substance with the second substance in the mixing container, thereby forming a tinted texturing material suitable for coating a surface, the tinted texturing material having a consistency greater than paint.

13. The method of mixing a tinted texturing material of claim 12 wherein the second substance includes an adhering property to adhere the tinted texturing material to the surface.

14. The method of mixing a tinted texturing material of claim 12 wherein the first substance is mixed with the second substance at a ratio of one to one.

15. The method of mixing a tinted texturing material of claim 12 wherein the second substance is a conventional dry joint compound.

16. The method of mixing a tinted texturing material of claim 12 wherein the first substance is a conventional latex paint.

17. The method of mixing a tinted texturing material of claim 12 wherein the second substance is a concrete material.

18. The method of mixing a tinted texturing material of claim 12 further comprising, after the step of mixing the first substance with the second substance, the step of applying the tinted texturing material to a surface.

19. The method of mixing a tinted texturing material of claim 12 further comprising the step of mixing a third substance with the first and second substances.

20. A tinted texturing mixture for application on a surface, the tinted texturing mixture comprising:
a first substance having a coloring property, the first substance being a latex paint;
a second texturing substance for increasing a consistency of a mixture with the first substance, the second substance being a conventional joint compound having an adherence property;
the first substance being mixed with the second substance in a ratio of approximately one to one to form the tinted texturing mixture, the tinted texturing mixture having a consistency greater than paint;
whereby the tinted texturing mixture provides a color throughout the mixture, the tinted texturing mixture being applied to the surface.
